(19) United States
(12) Patent Application Publication
(10) Pub. No.: US 2020/0019930 A1
(43) Pub. Date: Jan. 16, 2020

(54) THEMED OPERATIONS OF SMART LOCKER DEVICE

(71) Applicant: SMIOTA, INC., Pleasanton, CA (US)

(72) Inventors: MANJUNATHA KASHI, San Jose, CA (US); JYOTHI KASHI, San Jose, CA (US); Albert Calpito, Pleasanton, CA (US)

(21) Appl. No.: 16/560,691

(22) Filed: Sep. 4, 2019

Related U.S. Application Data
(63) Continuation-in-part of application No. 15/092,585, filed on Apr. 6, 2016.
(60) Provisional application No. 62/727,280, filed on Sep. 5, 2018.

(51) Int. Cl. G06Q 10/08; G07C 9/00

(52) U.S. Cl. CPC G06Q 10/0836; G07C 2009/00801; G06Q 10/0833; G07C 9/00912

(57) ABSTRACT

Disclosed herein are systems and methods for generating music data and display data in connection with a smart locker device. In an embodiment, disclosed is a method comprising generating a set of music data for execution by a processor of a smart locker device, wherein the set of music data is generated based on a set of package data corresponding to a package within a compartment of the smart locker device. The method can also generate a set of presentation data for execution by a processor of the smart locker device, wherein the set of presentation data is generated based on the set of package data corresponding to the package within a compartment of the smart locker device.

### CROSS-REFERENCE TO RELATED APPLICATION

This application claims priority to U.S. Patent Application No. 62,727,280 titled, “Generating Smart Locker Media Content”, and filed on Sep. 5, 2018. This application also claims priority to U.S. patent application Ser. No. 15,092,585 titled, “Devices, Systems, and Methods for Storing Items”, and filed on Apr. 6, 2016, which claims priority to U.S. Patent Application No. 62,146,187 titled, “Smart Mailbox System” and filed on Apr. 10, 2015. The entirety of the disclosures of the aforementioned applications are considered part of, and is incorporated by reference in, the disclosure of this application.

### BACKGROUND

Often users of digital devices prefer to utilize devices customized to their tastes, preferences and needs. However, in several instances, most devices do not allow for such customization capabilities. Given the increase in use of digital devices, there is a need to resolve the issues contributing to a dearth of technologies allowing for customization of digital devices such as smart lockers.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ system components to generate music data and display data within a smart locker device.

According to an embodiment, a system is provided. The system comprises a processor that executes computer executable components stored in memory. The computer executable components comprise a music component that generates a set of music data for execution by a processor of a smart locker device, wherein the set of music data is generated based on a set of package data corresponding to a package within a compartment of the smart locker device. Further, the computer executable components can comprise a presentation component that generates a set of presentation data for execution by a processor of the smart locker device, wherein the set of presentation data is generated based on the set of package data corresponding to the package within a compartment of the smart locker device. In another aspect, the computer executable components can comprise an output component that emits music from the smart locker device or displays video data or graphic data at a display component of the smart locker device based on the set of music data or the set of presentation data respectively.

According to another embodiment, a computer-implemented method is provided. The computer-implemented method can comprise generating a set of music data for execution by a processor of a smart locker device, wherein the set of music data is generated based on a set of package data corresponding to a package within a compartment of the smart locker device. The computer-implemented method can also comprise generating a set of presentation data for execution by a processor of the smart locker device, wherein the set of presentation data is generated based on the set of package data corresponding to the package within a compartment of the smart locker. In an aspect, the computer-implemented method can also comprise emitting music from an output component of the smart locker device or displaying graphics at a display component of the smart locker device based on the set of music data or the set of presentation data respectively.

### BRIEF DESCRIPTION OF THE DRAWINGS

FIG. 1 illustrates a block diagram of an example, non-limiting locker music system that can facilitate the generation of music data or presentation data by a smart locker device.

FIG. 2 illustrates a flow diagram of an example, non-limiting computer-implemented method that can facilitate a generation or music data or presentation data by a smart locker device.

FIG. 3 illustrates a flow diagram of an example, non-limiting computer-implemented method that can facilitate a generation or music data or presentation data by a smart locker device.

FIG. 4 illustrates a flow diagram of an example, non-limiting computer-implemented method that can facilitate a generation or music data or presentation data by a smart locker device.

FIG. 5 illustrates a block diagram of an example, non-limiting operating environment in which one or more embodiments described herein can be facilitated.

FIG. 6 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, this disclosure provides for a smart locker device comprising a memory and processor and capable of executing a music component that generates music data in order to facilitate a playing of music from an output component (e.g., speaker), such as a speaker component of the smart locker device. In a non-limiting embodiment, the smart locker device can commence execution (e.g., using a processor) of the generated music data (e.g., playing music) by music component based on an occurrence of an interactive event with the smart lockers such as an opening of smart locker compartment door (e.g., to retrieve or insert a package), entering information at a user interface of the smart locker device or mobile device, standing in front of the smart locker device (e.g., triggering an identification sensor). For instance, a user can open the compartment of a smart locker device to retrieve the contents (e.g., a birthday package) and upon the occurrence of opening a compartment to the smart locker door, the music component can be executed (e.g., using the processor) resulting in music (e.g., happy birthday song) output by the smart locker device speakers.

In another non-limiting embodiment, the smart locker device can employ a presentation component that displays a set of graphics, video, and/or illustrations at a user interface (e.g., smart locker screen, user mobile device, etc.) in relation to a particular theme. For instance, the user retrieving his package in the previous example can view, at a user interface (e.g., a display screen) of the smart locker device, celebratory graphics based on the existence of the users' birthday and upon retrieval (e.g., opening locker compartment door) of a birthday package. As such, a graphical representation of balloons, a birthday cake, streamers and/or other celebratory variations can be displayed on the user interface of the smart lockers. Furthermore, in an aspect, the playback of music (via a smart locker device output component) and the rendering of graphics (via a smart locker device user interface) can incorporate the same themes or different themes than one another. For instance, presentation component of a smart locker device can display a birthday themed graphical representation at the user interface while the music component can play a birthday song that synchronizes with such birthday themed graphical representation. However, in another aspect, the presentation component can display a different theme than the music that is playing. For instance, during the holiday season, presentation component can display Christmas graphics while a user that retrieves a birthday package from a locker compartment can listen to birthday music outputted from speakers of the smart locker based on an execution of music component upon the opening of a compartment door.

In an aspect, a music and display theme systems employed by a smart locker device can utilize various sets of data to determine the type of music generated and played (e.g., using music component) and type of display content generated and presented (e.g., using presentation component) by the smart locker device. For instance, the smart locker device can utilize label data, preference data, user submitted input data, predictive data, behavior data, and/or other data sets to determine the music and display themes for playing and presenting music and/or graphics respectively. For instance, in an aspect, packages delivered to a user can contain a variety of data that can represent information such as a source store or company from where the package (e.g., toy store, cookware store, etc.) departed, a source region or address of the package, storage instructions of the package, the name of sender (e.g., first name, last name, suffix, etc.), a postage stamp displaying a particular image, a relationship between the sender and recipient (e.g., parent, sibling, etc.), a genre of product that is connected to a musical theme or image theme, and other such data. In an aspect, such data can be utilized by music component and/or presentation component to generate relevant music data for playback or relevant graphical data for display at a user interface (e.g., of smart locker device 141 or consumer device(s) 122).

In an aspect, smart locker device 144 can be communicatively coupled to a package analysis device that can read label data. For instance, the package analysis device can employ optical character recognition technology to extract information related to a package and compare such data including identification data (e.g., username, UUID information, etc.) to match the package data to respective metadata, such as theme information (e.g., birthday package, Christmas package, etc.). In another instance, if the label data indicates that the item in the package is a gift, then music component can play music indicating the occasion for the gift (e.g., holiday, birthday, anniversary) and presentation component can display graphical images representing a gift-type of theme (e.g., a present with a bow presented at the user interface). In another aspect, music components (not illustrated) and presentation components (not illustrated) of the smart locker device 141 can use preference data representing information such as a users' bookmark information, social media information (e.g., likes, groups, locations visited, etc.), cookie information, music library favorites, video library favorites, and other such information represented as data. In an instance, the music component and presentation component can determine music for playing and graphics for displaying based on a prediction of a users' preference based on historical preference data.

In another aspect, a user can submit input data requesting particular music for graphical playback based on user preference. For instance, a sender consumer device 122 can transmit (e.g., via first transmission component 110) a request to a smart locker device employing the disclosed system to play a football fight song to a recipient user (e.g., third party device 126) that is a fan of a football team upon receipt of a package from consumer device 122. In another instance, a university with smart locker device(s) 141 installed within the university dormitory can utilize music component to employ playback of a university football fight song, college graduation song, alma mater music, and other such university-focused musical compositions or graphical displays for employment by the smart locker device upon users opening compartment doors of the smart locker device or simply playing during desired time ranges.

In another non-limiting embodiment, a central control system can transmit operational instructions and/or requests to smart locker device(s) 141 that employ artificial intelligence components to predict music for generation by a prediction component employed by a music component and/or predict graphics for display by presentation component based on various prediction criteria. In an aspect, a prediction component can predict preferential or target music for playback or graphics for display at a smart locker device 141 user interface based on data sources from package labels, e-commerce platforms, social media, user preference sources, user behavior sources, user submissions, media content consumption information, and other such data in order to predict and automatically generate music (e.g., using music component in connection with prediction component) for playing and generating (e.g., using presentation component) graphics to display (e.g., at a graphical user interface of the smart lockers).

In an aspect, prediction component (of central control system 128) can predict a songs relevancy to a particular event corresponding to a user device receiving a package based on weighted criteria. For instance, prediction component can weight a set of data associated with a media content item (e.g., song) such as frequency a song is mentioned in association with an event or holiday, frequency an artist, genre, or song style is associated with a respective holiday, the association of a particular package with a holiday (e.g., a type of toy within a package, such as an elf, may be associated with Christmas), song popularity data, familiarity data, critic review data, publicity data, and other such attributes can be weighted to arrive at a predicted song for playing. Furthermore, the content of a package can be associated with a vector of terms coupled to predictive probability weights. For instance, a package that has been selected from a purchase list associated with a baby shower and containing diapers can comprise predictive qualities related to various media content items. Furthermore, those predictive qualities can be utilized as inputs within a predictive model employed by a prediction component of central control system 128.

As an example procedure or prediction component predicting a music item for playback, prediction component can utilize package data to determine a set of terms and weights associated with the package and/or theme associated with the package and/or package contents. Furthermore, a set of terms and corresponding weights can be associated with the item within the package and event associated with the package and such terms and term weights can be utilized by a prediction model to generate an input vector. The input vector can be used as input to train a predictive model comprising target data comprised of test data corresponding to a target metric of data (e.g., music data correlating to an event and user preference). Furthermore, a value can be generated and output for each term corresponding to an association with the term and a target metric. For instance, a target metric can be a score associated with a song title in relation to the type of package and event stored in a compartment of smart locker device 141.

In another aspect, prediction component can also employ pattern recognition techniques to receive data related to packages and predict the type of media content item (e.g., music or graphic) a user may like to consume in connection with receiving a package. For instance, prediction component can employ clustering techniques that group a set of objects (e.g., label data, music preference data, social media data, etc.) into a group based on the similarity of the objects to one another. Furthermore, the clusters can be utilized to perform exploratory data mining operations (e.g., finding similar data points that inform music playing and graphical display preferences of a user or group of users), statistical data analysis (e.g., determining frequency, average times, and other statistics related to a users' playing of various music songs and/or consumption of graphics/video), machine learning (e.g. performing supervised learning to determine where new data points belong), pattern recognition (e.g., identifying patterns related to music and video consumption as well as user preference patterns using data), image analysis, information retrieval, data compression, and/or computer graphics.

In an instance, package data can be grouped (e.g., by prediction component) based on a type of package destination of the package, package receiver, retail store the package was shipped from, etc. in order to determine package type clusters. Furthermore, the package details can be used to predict the music and themes for playing and displaying at a user interface of the smart locker device. In another aspect, data from later packages can be grouped into existing clusters or any previously grouped data can be regrouped based on newly discovered trends and/or patterns identified by prediction component.

In another aspect, a machine learning technique can be employed by prediction component in which an external body of information (e.g., historical data, data stores, etc.) can be analyzed by applying machine learning, data mining, or other statistical operations (e.g., using keywords to derive new keywords) in order to generate a music generation model to facilitate a predictive playing of music within the smart locker devices. In an instance, the prediction component can utilize machine learning computations associated with one or more inputs and/or one or more outputs to determine a portion of package data and its connection to a data group (e.g., whether it can be categorized within a data group). Such determination can facilitate an evaluation of parameters corresponding to previous package data that were coupled to music data. Furthermore, the data group can indicate a likelihood that a particular musical composition would or would not be a good fit for accompanying retrieval of such package based on the evaluation of previous instances of music data being coupled to similar package data (e.g., positive or negative user experiences).

In another aspect, the prediction component can utilize machine learning techniques to train the system to explicitly or implicitly determine or infer music data to execute in association with a particular compartment of a smart locker device to achieve an individualized and customized user experience. In another aspect, machine learning techniques can be employed to identify portions of music data sets and/or package data sets that correspond to a positive user experience or negative user experience. Furthermore, the machine learning techniques can identify suitable alternatives of music data or similar music data sets that can create similar positive user experiences customized to individual users of smart lockers. In an aspect, the prediction component can employ machine learning techniques to source data from relevant libraries (e.g., data sources) to significantly enhance the identification of appropriate music to execute for a particular user. As such, prediction component can employ machine learning techniques that can learn to determine or infer a music data type for execution by a processor of the smart locker device in association with a particular package being delivered or received by/from a user.

In another aspect, a processor of the smart locker device can be associated with at least one of a central processor, a graphical processor, etc. In various embodiments, the processor can be or include hardware, software (e.g., a set of threads, a set of processes, software in execution, etc.) or a combination of hardware and/or software that performs a computing task for machine learning (e.g., a machine learning computing task associated with received data). For example, the processor can execute data analysis threads that cannot be performed by a human (e.g., are greater than the capability of a single human mind). For example, the amount of data processed, the speed of processing of the data and/or the data types processed by processor over a certain period of time can be respectively greater, faster and different than the amount, speed and data type that can be processed by a single human mind over the same period of time. For example, data processed by processor can be raw data (e.g., raw audio data, raw video data, raw textual data, raw numerical data, etc.) and/or compressed data (e.g., compressed audio data, compressed video data, compressed textual data, compressed numerical data, etc.) captured by one or more sensors and/or one or more computing devices. Moreover, one or more processor can be fully operational towards performing one or more other functions (e.g., fully powered on, fully executed, etc.) while also processing the above-referenced data analysis data and runtime environment data. In other non-limiting embodiments, the music components and presentation components can be coordinated through cloud computing technologies for implementation on several smart locker devices and/or mobile devices.

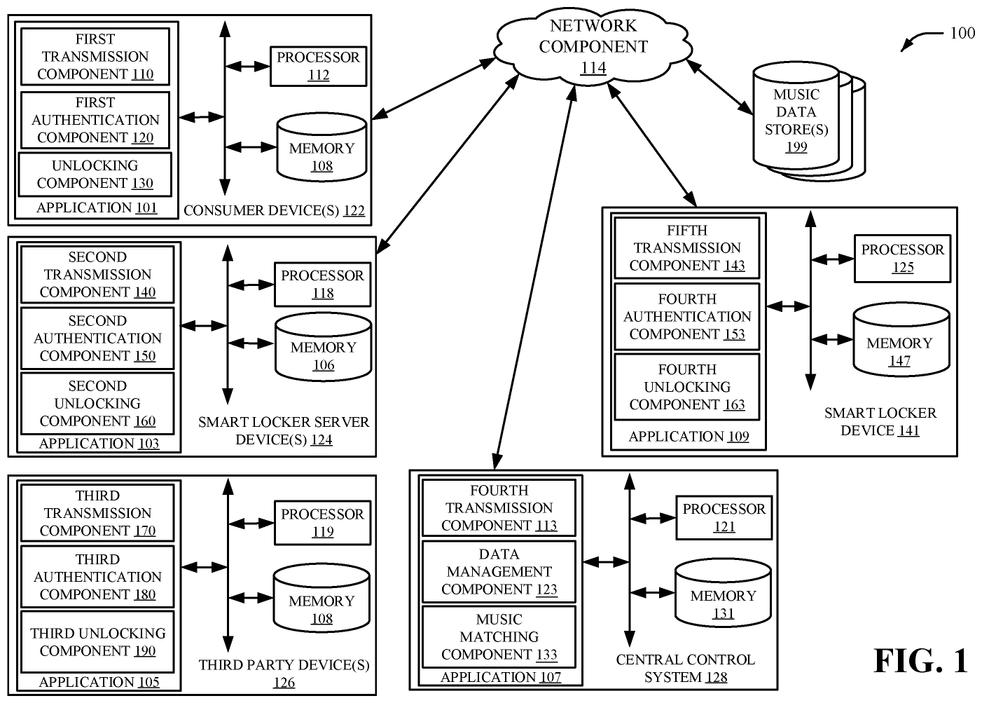

Turning now to FIG. 1, illustrated is a block diagram of an example, non-limiting locker music system 100 that can facilitate the generation of music data or presentation data by a smart locker device. In an aspect, music system 100 can comprise several devices including, but not limited to, consumer device(s) 122, smart locker server device(s) 124, third party device(s) 126, central control system 128, and smart locker device 141. In a non-limiting embodiment, consumer device(s) 122 can represent a mobile device (e.g., smart phone, personal digital assistant, tablet, etc.) that executes application 101 that can execute an array of components associated with execution of various operations. For instance, consumer device(s) 122 can allow a user to transmit data, requests, instructions, etc. using first transmission component 110. In an aspect, first transmission component 110 can enable a user device to select an item from a list of items requested for purchase. In an aspect, such list of items can be displayed and accessible to a public group or a private group of user devices.

As such a group of other user devices can access the list of items and purchase one or more list of items for delivery to the primary user device generating the list of items. Furthermore, the list of items can be associated with an event, occasion or theme such as a birthday, holiday gift, or special occasion event. In an aspect, metadata associated with the list of items (e.g., information associated with the item and the occasion to which it corresponds) can be stored at a data store such as a data store at a central control system 128. In an aspect, central control system 128 can execute application 107 that performs operations associated with all devices within music system 100. In an instance, central control system 128 can receive selection data from a third-party device(s) 126. For instance, a friend of the user associated with consumer device(s) 122 that selects, purchases and executes a package shipment of a birthday gift from a birthday list of consumer device(s) 122. As such, application 105 can execute third transmission component 170 to transmit purchase instruction data and package item selection data to a data store of central control system 128.

Furthermore, in an aspect, central control system 128 can execute data management component 123 to generate package data (e.g., purchase data from third party device 126, identification data of third party device 126, consumer device 122 and associated identification data, delivery data, theme data (occasion of package item), and other such information. In another aspect, data management component 123 can continue to update package data as events associated with the item occur. For instance, data management component can flag package data as purchased, picked-up, in transit, delivered, and other such designations as the package proceeds through transit. Furthermore, data management component 123 can coupled other data sets with package data such as tracking number information, intended recipient, courier data, and other such information.

In another aspect, consumer device(s) 122 can access central control system 128 to ascertain the status of packages, list of items, and other such information. Furthermore, upon delivery of a package item to a respective compartment of smart locker device 141 associated with consumer device(s) 122, the package item, the delivery can trigger fifth transmission component 143 executing on application 109 of smart locker device 141 to transmit delivery data to central control system 128 and trigger fourth transmission component 113 to transmit notification data to application 101 of consumer device(s) 122. As such, consumer device(s) 122 can receive an access code from fourth transmission component 113 and transmit such access code to smart locker device 141 as input data. Furthermore, fifth transmission component 143 can transmit the access code data to data management component 123 and upon verification that the access code corresponds with application 101 executing on consumer device(s) 122, fourth transmission component 113 can transmit unlocking instructions to fourth unlocking component 163 that unlocks the respective compartment of smart locker device 141. Furthermore, fourth transmission component in connection with music matching component 133 can couple music data to the unlock data such that upon unlocking of the compartment of smart locker device 141, music can be executed by smart locker device 141.

In an aspect, music matching component 133 can predict a set of music data to transmit to smart locker data based on any range of determinations such as user preference, event associated with the package, metadata associated with third party music data stores (e.g., music data store(s) 199, and other such criteria. Furthermore, a music selection can be selected from a range of music selections based on a predictive value associated with each music selection as compared to a threshold value representing a user preference level for such music type (e.g., detection of frequency a music song is played, browser history data, similarity to music attributes preferred by a user (e.g., artist, genre, instruments, singer, tempo, etc.). In another aspect, smart locker server device(s) 124 can employ application 103 to execute a range of operations associated with smart locker device 144. For instance, consumer device 122, third party device 126, smart locker device 141 can employ first authentication component 120, third authentication component 180, and fourth authentication component 153 to submit authentication data to second authentication component 150 of smart locker server device 124. In an aspect, second authentication component 150 can determine the validity and permission of each such device to perform and execute various smart locker operations. Furthermore, each device can execute an unlocking operation (e.g., using unlocking component 130, second unlocking component 160, third unlocking component 190, fourth unlocking component 163, etc.) of smart locker device 141 based on authentication operations and other such factors.

In another non-limiting embodiment, central control system 128 can extract music preference data and/or music data from music data store(s) 199 associated with third party music applications. Furthermore, even in the absence of theme data and other such information, smart locker device 141 can generate music upon execution of an unlock operation to a compartment of smart locker device 141. For instance, fifth transmission component 143 can poll for music data from music matching component 133 and upon the absence of music data or theme data, music matching component 133 can access music data from music data store(s) 199 to transmit to fourth transmission component 113 and back to fifth transmission component 143.

In another aspect, each respective device can employ one or more processor (e.g., processor 112, processor 118, processor 119, processor 121, processor 125) to execute computer executable components and/or computer executable instructions stored in a memory (e.g., memory 108, memory 106, memory 108, memory 131, memory 147). In another aspect, the device(s) can communicate over a network 114 over which data can be exchanged and/or firmware can be employed to process messages used in maintaining a wireless or wired communication session and perform other such operations. In an aspect, network component 114 can represent any suitable type of communication network such as cloud computing networks that facilitate a bi-directional link between various computing devices. In an aspect, network component 114 can include more than one interconnected communication networks that comprise a plurality of interconnected elements, such as Ethernet access and wireless local area network (WLAN), a wireless telecommunication network interconnected with the Internet, a wireless (e.g., Wi-Fi) access point connected to the Internet, an Internet of Things (IoT) network (e.g., smart label device network), and other such communication networks or interconnected elements. In another non-limiting embodiment, server device(s) 102, computing device(s) 104, and smart label device(s) 106 can communicate over network component 114.

In another non-limiting embodiment, smart locker device can recommend or output particular media content (e.g., music) based on threshold determinations. In an aspect, central control system 128 can build one or more machine learning models that can be used to select media content items for playback by the smart locker device during one or more activities associated with the smart locker device or events associated with a user utilizing the smart locker device. For instance, central control system can employ determination components that can determine whether a particular media content item is suitable for a particular event, such as a birthday, anniversary, holiday, baby shower, costume party, honeymoon, funeral, New Year, reception, or other such celebratory event. In an aspect, the determination component can assign scores to respective media content items based on the relevancy of such media content item for playback during a smart locker device activity (e.g., unlocking a locker, dropping off a package, etc.).

In an aspect, the determination component can employ a filtration component to filter media content items for playback based on various attributes such as speed of song, cadence of song, user preference criteria, genre, tempo, and other such attributes. Furthermore, the central control system 128 can employ a user experience threshold that can compare a score of each media content item to a score associated with a predicted user experience from playback of such media content item based on an occurrence of a given event. In some embodiments, media content items that surpass a threshold score can be played as a playlist, where each media content item in the playlist can be assigned a weight (e.g., by a weighting component) to determine an order of playing such media content items. For instance, a weighting component can weigh songs within a playlist based on various weighting schemes that weight words in a song based on a comparison to keywords associated with an event (e.g., winter, wonderland, cheer and other such words for a Christmas event). Other weighting factors can include weighting media content items based on selection by a user or a streaming service, weighting media content items that have more or less followers, weighting media content items played fewer or more times by a user, and other such factors. As such, the smart locker can provide playback of media content items (e.g., graphics, music, etc.) based on various criteria associated with a user event.

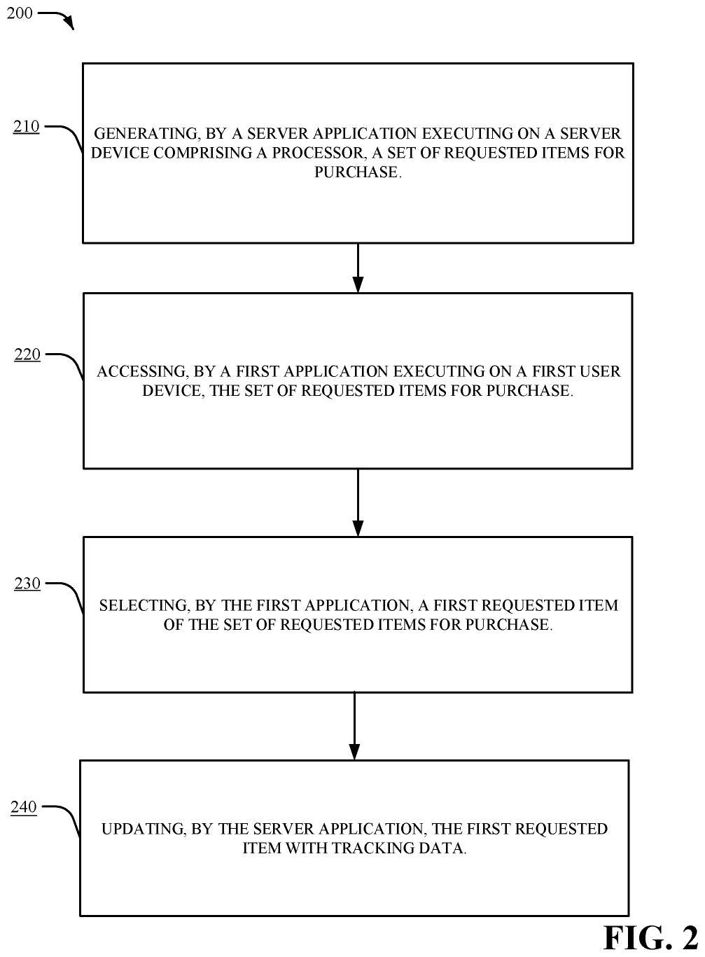

Turning now to FIG. 2, illustrated is a flow diagram of an example, non-limiting computer-implemented method 200 that can facilitate a generation or music data or presentation data by a smart locker device. Repetitive description of like elements employed in other embodiments described herein is omitted for sake of brevity. At reference numeral 210, a server application executing on a server device comprising a processor generates a set of requested items for purchase. At reference numeral 220, a first application executing on a first user device accesses the set of requested items for purchase. At reference numeral 230, the first application selects a first requested item of the set of requested items for purchase. At reference numeral 240, the server application updates the first requested item with tracking data.

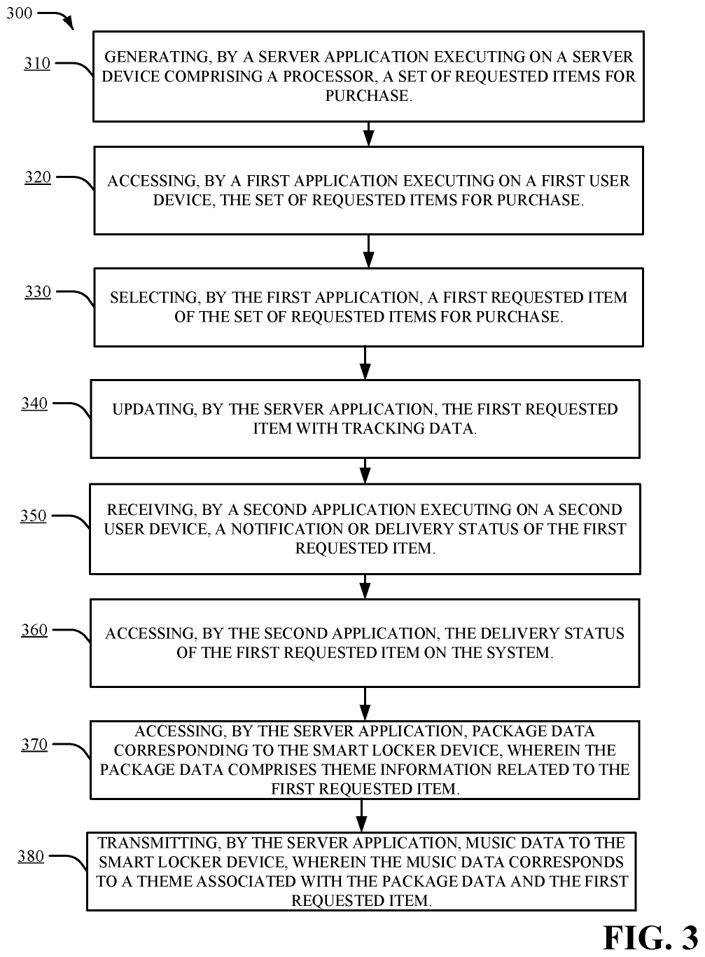

Turning now to FIG. 3, illustrated is a flow diagram of an example, non-limiting computer-implemented method 300 that can facilitate a generation or music data or presentation data by a smart locker device. Repetitive description of like elements employed in other embodiments described herein is omitted for sake of brevity. At reference numeral 310, a server application executing on a server device comprising a processor generates a set of requested items for purchase. At reference numeral 320, a first application executing on a first user device, accesses the set of requested items for purchase. At reference numeral 330, the first application selects a first requested item of the set of requested items for purchase. At reference numeral 340, the server application updates the first requested item with tracking data. At reference numeral 350, the second application executing on a second user device receives a notification or delivery status of the first requested item. At reference numeral 360, the second application, accesses the delivery status of the first requested item on the system. At reference numeral 370, the server application accesses package data corresponding to the smart locker device, wherein the package data comprises theme information related to the first requested item. At reference numeral 380, the server application transmits music data to the smart locker device, wherein the music data corresponds to a theme associated with the package data and the first requested item.

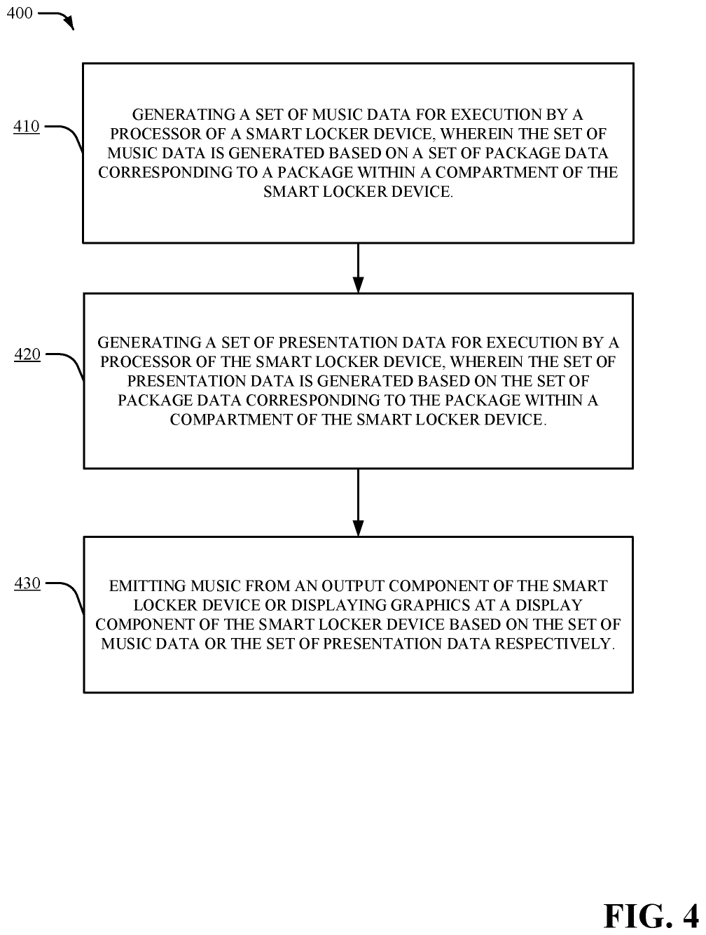

Turning now to FIG. 4, illustrated is a flow diagram of an example, non-limiting computer-implemented method 400 that can facilitate a generation or music data or presentation data by a smart locker device. Repetitive description of like elements employed in other embodiments described herein is omitted for sake of brevity. At reference numeral 410, a set of music data is generated for execution by a processor of a smart locker device, wherein the set of music data is generated based on a set of package data corresponding to a package within a compartment of the smart locker device. At reference numeral 420, a set of presentation data is generated for execution by a processor of the smart locker device, wherein the set of presentation data is generated based on the set of package data corresponding to the package within a compartment of the smart locker device. At reference numeral 430, music is emitted from an output component of the smart locker device or graphics are displayed at a display component of the smart locker device based on the set of music data or the set of presentation data respectively.

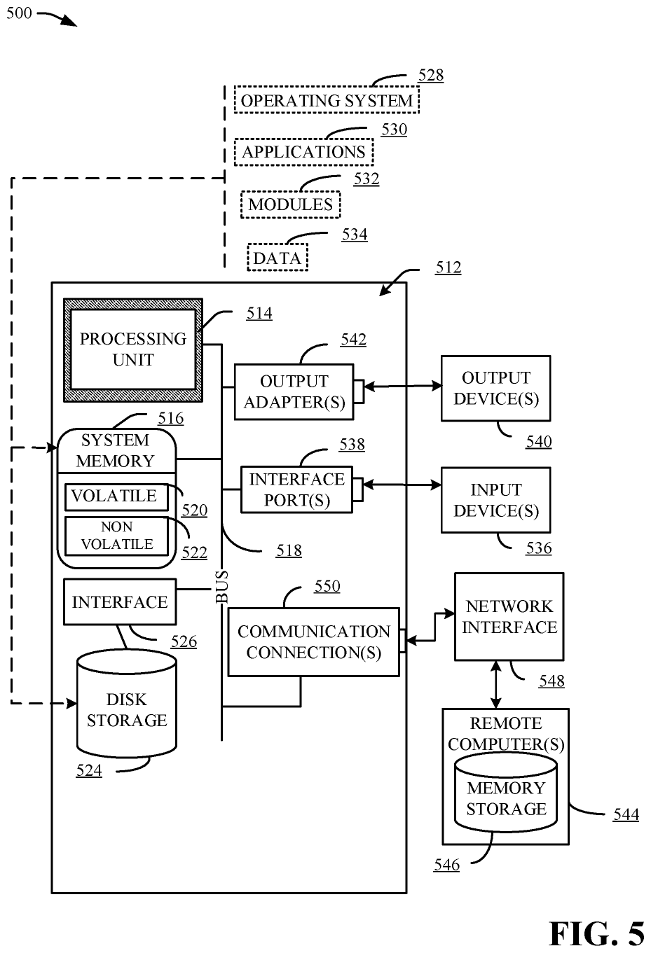

In order to provide a context for the various aspects of the disclosed subject matter, FIG. 5 as well as the following discussion is intended to provide a general description of a suitable environment in which the various aspects of the disclosed subject matter can be implemented. FIG. 5 illustrates a block diagram of an example, non-limiting operating environment in which one or more embodiments described herein can be facilitated. With reference to FIG. 5, a suitable operating environment 500 for implementing various aspects of this disclosure can also include a computer 512. The computer 512 can also include a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514. The system bus 518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 516 can also include volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 512 can also include removable/non-removable, volatile/non-volatile computer storage media. FIG. 5 illustrates, for example, a disk storage 524. Disk storage 524 can also include, but is not limited to, devices like a magnetic disk drive, floppy disk drive, tape drive, Jaz drive, Zip drive, LS-100 drive, flash memory card, or memory stick. The disk storage 524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 524 to the system bus 518, a removable or non-removable interface is typically used, such as interface 526. FIG. 5 also depicts software that acts as an intermediary between users and the basic computer resources described in the suitable operating environment 500. Such software can also include, for example, an operating system 528. Operating system 528, which can be stored on disk storage 524, acts to control and allocate resources of the computer 512.

System applications 530 take advantage of the management of resources by operating system 528 through program modules 532 and program data 534, e.g., stored either in system memory 516 or on disk storage 524. It is to be appreciated that this disclosure can be implemented with various operating systems or combinations of operating systems. A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port can be used to provide input to computer 512, and to output information from computer 512 to an output device 540. Output adapter 1242 is provided to illustrate that there is some output device 540 like monitors, speakers, and printers, among other such output device 540, which require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a computer, a server, a router, a network PC, a workstation, a microprocessor based appliance, a peer device or other common network node and the like, and typically can also include many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 550 refers to the hardware/software employed to connect the network interface 548 to the system bus 518. While communication connection 550 is shown for illustrative clarity inside computer 512, it can also be external to computer 512. The hardware/software for connection to the network interface 548 can also include, for exemplary purposes only, internal and external technologies such as, modems including regular telephone grade modems, cable modems and DSL modems, ISDN adapters, and Ethernet cards.

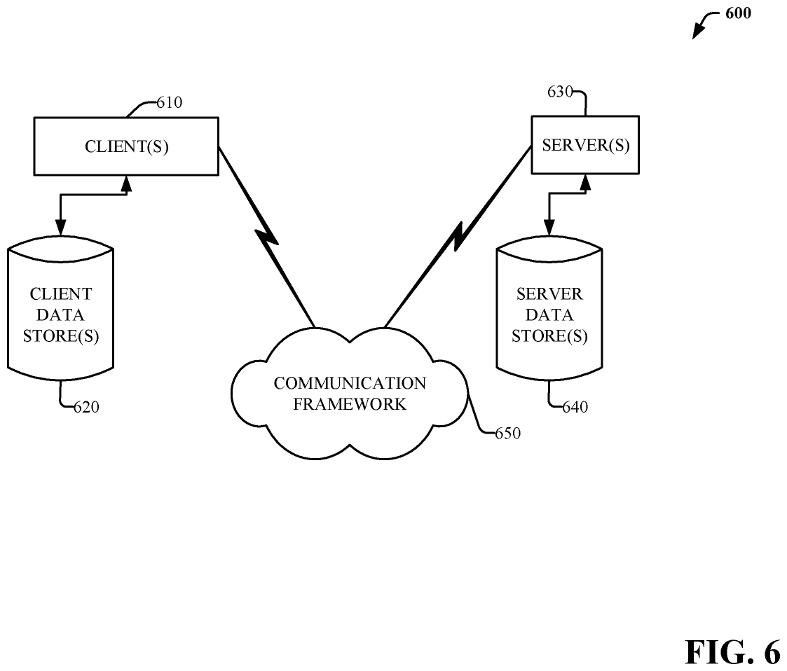

Referring now to FIG. 6, there is illustrated a schematic block diagram of a computing environment 600 in accordance with this disclosure. The system 600 includes one or more client(s) 602 (e.g., laptops, smart phones, PDAs, media players, computers, portable electronic devices, tablets, and the like). The client(s) 602 can be hardware and/or software (e.g., threads, processes, computing devices). The system 600 also includes one or more server(s) 604. The server(s) 604 can also be hardware or hardware in combination with software (e.g., threads, processes, computing devices). The servers 604 can house threads to perform transformations by employing aspects of this disclosure, for example. One possible communication between a client 602 and a server 604 can be in the form of a data packet transmitted between two or more computer processes wherein the data packet may include video data. The data packet can include a metadata, e.g., associated contextual information, for example. The system 600 includes a communication framework 606 (e.g., a global communication network such as the Internet, or mobile network(s)) that can be employed to facilitate communications between the client(s) 602 and the server(s) 604.

Communications can be facilitated via a wired (including optical fiber) and/or wireless technology. The client(s) 602 include or are operatively connected to one or more client data store(s) 608 that can be employed to store information local to the client(s) 602 (e.g., associated contextual information). Similarly, the server(s) 604 are operatively include or are operatively connected to one or more server data store(s) 610 that can be employed to store information local to the servers 604. In one embodiment, a client 602 can transfer an encoded file, in accordance with the disclosed subject matter, to server 604. Server 604 can store the file, decode the file, or transmit the file to another client 602. It is to be appreciated, that a client 602 can also transfer uncompressed file to a server 604 and server 604 can compress the file in accordance with the disclosed subject matter. Likewise, server 604 can encode video information and transmit the information via communication framework 606 to one or more clients 602.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
generating, by one or more processor of a smart locker device, a set of music data, wherein the set of music data is generated based on a set of package data corresponding to a package within a compartment of the smart locker device;
generating, by the one or more processor of the smart locker device, a set of presentation data, wherein the set of presentation data is generated based on the set of package data corresponding to the package within a compartment of the smart locker; and
emitting, by the smart locker device, music via an output component or graphics at a display component of the smart locker device based on the set of music data or the set of presentation data respectively.

2. A system comprising:
a memory that stores computer executable components;
a processor that executes the computer executable components stored in the memory, wherein the computer executable components comprise:
a music component that generates a set of music data for execution by a processor of a smart locker device, wherein the set of music data is generated based on a set of package data corresponding to a package within a compartment of the smart locker device;
a presentation component that generates a set of presentation data for execution by a processor of the smart locker device, wherein the set of presentation data is generated based on the set of package data corresponding to the package within a compartment of the smart locker; and
an output component that emits music from the smart locker device or displays video data or graphic data at a display component of the smart locker device based on the set of music data or the set of presentation data respectively.

3. A method comprising:
generating, by a server application executing on a server device comprising a processor, a set of requested items for purchase;
accessing, by a first application executing on a first user device, the set of requested items for purchase;
selecting, by the first application, a first requested item of the set of requested items for purchase;
updating, by the server application, the first requested item with tracking data;

4. The method of claim 3, further comprising:
receiving, by a second application executing on a second user device, a notification or delivery status of the first requested item; and
accessing, by the second application, the delivery status of the first requested item on the system.

5. The method of claim 4, further comprising:
receiving, by the second application, another notification representing a delivery of the first requested item to a locker compartment of a smart locker device; and
receiving, by the second application, an access code configured to unlock a door of the locker compartment.

6. The method of claim 4, further comprising:
transmitting, by the second application, the access code to the server application;
verifying, by the server application, the access code based on a comparison of first application credentials to a set of authorized credentials;
transmitting, by the server application, an unlock request to the smart locker device; and
unlocking the door of the locker compartment based on the unlock request.

7. The method of claim 6, further comprising:
accessing, by the server application, package data corresponding to the smart locker device, wherein the package data comprises theme information related to the first requested item;
transmitting, by the server application, music data to the smart locker device, wherein the music data corresponds to a theme associated with the package data and the first requested item; and
outputting, by a media device of the smart locker device, audio music based on an opening of the door, wherein the audio music is output based on an execution of the music data.

8. (canceled)

9. (canceled)
